(19) United States
(12) Patent Application Publication
(10) Pub. No.: US 2008/0024421 A1
(43) Pub. Date: Jan. 31, 2008

(54) Liquid crystal display driver and liquid crystal display device mounting the same

(76) Inventor: Kiyoshi Hidaka, Kanagawa-ken (JP)

Correspondence Address: SPRINKLE IP LAW GROUP, 1301 W. 25TH STREET, SUITE 408, AUSTIN, TX, 78705, US

(21) Appl. No.: 11/879,682

(22) Filed: Jul. 18, 2007

(30) Foreign Application Priority Data
Jul. 20, 2006 (JP) P2006-198457

(51) Int. Cl. G09G 3/36

(52) U.S. Cl. 345/99

(57) ABSTRACT

A liquid crystal display driver comprising: a first register for writing a setting value for display in response to a write control signal asynchronous with a clock signal outputted at a timing of switching display cycles; first data holding unit which holds an output from the first register in response to the clock signal; racing monitoring period setting unit which sets a period for monitoring an occurrence of racing in the output signal from the first register due to the timing of the clock signal; second data holding unit which holds an output from the first register in response to a clock signal which is the clock signal delayed for a period set by the racing monitoring period setting unit; racing detection unit which detects whether a racing state occurs in the output signal from the first register due to a timing of the clock signal; selection unit which outputs an output signal from the first register when the racing state is detected by the racing detection unit, and which outputs an output signal from the first data holding unit or an output signal from the second data holding unit when the racing state is not detected by the racing detection unit; delay unit which generates a delay clock signal which is the clock signal delayed until after the period set by the racing monitoring period setting unit; and a second register for writing an output signal from the selection unit in response to the delay clock signal.

### CROSS-REFERENCE TO RELATED APPLICATIONS

This application is based upon and claims the benefit of priority from the prior Japanese Patent Application No. 2006-198457, filed on Jul. 20, 2006, the entire contents of which are incorporated herein by reference.

### BACKGROUND

1. Field of the Invention

The present invention relates to a liquid crystal display driver and a liquid crystal display device mounting the same.

2. Description of the Related Art

In a liquid crystal display device, heretofore, in a case where setting values for display such as display size and the number of display colors are changed according to an instruction from a CPU, display may be disturbed if the setting is changed during a display period. Accordingly, the changed setting values are to be reflected on the display after one display cycle (field or frame) is terminated.

For this reason, a conventional liquid crystal display device is provided with registers composed of two stages. A setting value is written to a first stage register in response to a write control signal outputted from a CPU. Then, the output is written to a second stage register in response to a signal generated at a timing of switching display cycles. For example, refer to U.S. Pat. No. 6,806,872 (cols. 8-10, FIG. 1).

However, there is a problem that a so-called racing phenomenon occurs in writing to a second stage register, since a timing of generating a write control signal outputted from a CPU and a timing of switching display cycles are asynchronous.

In other words, when a timing of generating a write control signal outputted from a CPU and a timing of switching display cycles are close to each other, a time period between data input to a second stage register and a clock input may not be long enough to ensure a setup time or a hold time. Accordingly, it is uncertain whether an output from the second stage register would be a value before or after the change of the setting value.

For this reason, when a setting value for display is composed of a plurality of bits, it is uncertain which one of values before and after the change of the setting value would be outputted for each bit from the second stage register. As a result, there is a problem that a setting value outputted from the second stage register turns out to be an unintended value, and thereby display is disturbed.

### SUMMARY

According to an aspect of the present invention, there is provided a liquid crystal display driver comprising: a first register for writing a setting value for display in response to a write control signal asynchronous with a clock signal outputted at a timing of switching display cycles; first data holding unit which holds an output from the first register in response to the clock signal; racing monitoring period setting unit which sets a period for monitoring an occurrence of racing in the output signal from the first register due to the timing of the clock signal; second data holding unit which holds an output from the first register in response to a clock signal which is the clock signal delayed for a period set by the racing monitoring period setting unit; racing detection unit which detects whether a racing state occurs in the output signal from the first register due to a timing of the clock signal; selection unit which outputs an output signal from the first register when the racing state is detected by the racing detection unit, and which outputs an output signal from the first data holding unit when the racing state is not detected by the racing detection unit; delay unit which generates a delay clock signal which is the clock signal delayed until after the period set by the racing monitoring period setting unit; and a second register for writing an output signal from the selection unit in response to the delay clock signal.

According to another aspect of the present invention, there is provided a liquid crystal display driver comprising: a first register for writing a setting value for display in response to a write control signal asynchronous with a clock signal outputted at a timing of switching display cycles; first data holding unit which holds an output from the first register in response to the clock signal; racing monitoring period setting unit which sets a period for monitoring an occurrence of racing in the output signal from the first register due to the timing of the clock signal; second data holding unit which holds an output from the first register in response to a clock signal which is the clock signal delayed for a period set by the racing monitoring period setting unit; racing detection unit which detects whether a racing state occurs in the output signal from the first register due to a timing of the clock signal; selection unit which outputs an output signal from the first register when the racing state is detected by the racing detection unit, and which outputs an output signal from the second data holding unit when the racing state is not detected by the racing detection unit; delay unit which generates a delay clock signal which is the clock signal delayed until after the period set by the racing monitoring period setting unit; and a second register for writing an output signal from the selection unit in response to the delay clock signal.

According to another aspect of the present invention, there is provided a liquid crystal display device comprising:

a liquid crystal display driver having; a first register for writing a setting value for display in response to a write control signal asynchronous with a clock signal outputted at a timing of switching display cycles; first data holding unit which holds an output from the first register in response to the clock signal; racing monitoring period setting unit which sets a period for monitoring an occurrence of racing in the output signal from the first register due to the timing of the clock signal; second data holding unit which holds an output from the first register in response to a clock signal which is the clock signal delayed for a period set by the racing monitoring period setting unit; racing detection unit which detects whether a racing state occurs in the output signal from the first register due to a timing of the clock signal; selection unit which outputs an output signal from the first register when the racing state is detected by the racing detection unit, and which outputs an output signal from the first data holding unit when the racing state is not detected by the racing detection unit; delay unit which generates a delay clock signal which is the clock signal delayed until after the period set by the racing monitoring period setting unit; and a second register for writing an output signal from the selection unit in response to the delay clock signal: and

a liquid crystal panel

wherein the liquid crystal display driver changes setting for display of the liquid crystal panel at a timing of switching display cycles, in response to a setting value inputted from a CPU.

According to another aspect of the present invention, there is provided a liquid crystal display device comprising:

a liquid crystal display driver having; a first register for writing a setting value for display in response to a write control signal asynchronous with a clock signal outputted at a timing of switching display cycles; first data holding unit which holds an output from the first register in response to the clock signal; racing monitoring period setting unit which sets a period for monitoring an occurrence of racing in the output signal from the first register due to the timing of the clock signal; second data holding unit which holds an output from the first register in response to a clock signal which is the clock signal delayed for a period set by the racing monitoring period setting unit; racing detection unit which detects whether a racing state occurs in the output signal from the first register due to a timing of the clock signal; selection unit which outputs an output signal from the first register when the racing state is detected by the racing detection unit, and which outputs an output signal from the second data holding unit when the racing state is not detected by the racing detection unit; delay unit which generates a delay clock signal which is the clock signal delayed until after the period set by the racing monitoring period setting unit; and a second register for writing an output signal from the selection unit in response to the delay clock signal: and

a liquid crystal panel

wherein the liquid crystal display driver changes setting for display of the liquid crystal panel at a timing of switching display cycles, in response to a setting value inputted from a CPU.

### BRIEF DESCRIPTION OF THE DRAWINGS

FIG. 1 is a block diagram showing an example of a configuration of a liquid crystal display driver according to a first embodiment of the present invention.

FIG. 2 is a diagram for illustrating a racing problem due to the change of a setting value at a timing of switching display cycles.

FIG. 3 is a waveform chart showing an example of an operation of the liquid crystal display driver according to the first embodiment of the present invention.

FIG. 4 is a waveform chart showing another example of an operation of the liquid crystal display driver according to the first embodiment of the present invention.

FIG. 5 is a block diagram showing an example of a configuration of a liquid crystal display driver according to a second embodiment of the present invention.

### DETAILED DESCRIPTION

Hereinafter, embodiments of the present invention are described with reference to the accompanying drawings.

### First Embodiment

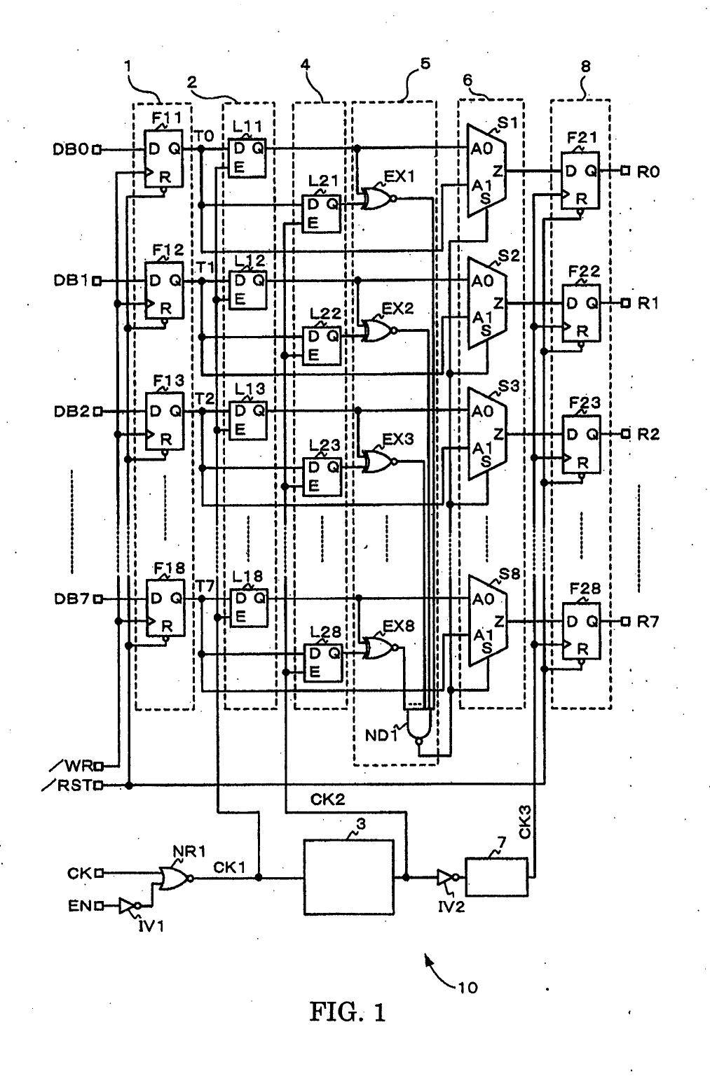

FIG. 1 is a block diagram showing an example of a configuration of a liquid crystal display driver according to a first embodiment of the present invention. In the present embodiment, a clock signal CK1 is used as a clock signal when a display cycle switching signal EN has been inputted. The clock signal CK1 is obtained by inputting, to an NOR gate NR1, signals that a clock signal CK and the display cycle switching signal EN have been inverted with an inverter IV1.

A liquid crystal display driver 10 of the present embodiment includes: a register 1 for writing data DB0 to DB7 of 8 bits which represents setting values for the display of a liquid crystal display device in response to a write control signal /WR asynchronous with the clock signal CK1; a data holding unit 2 for holding output signals T0 to T7 of the register 1 in response to the clock signal CK1; a racing monitoring period setting unit 3 for setting a period in which the occurrence of a racing to the clock signal CK1 of the output signals T0 to T7 of the register is monitored; a data holding unit 4 for holding outputs from the register 1 in response to a clock signal which delays the clock signal CK1 for a period set by the racing monitoring period setting unit 3; a racing detection unit 5 for detecting whether or not the change of the output signals T0 to T7 from the register 1 is in a racing state to the clock signal CK1; a selection unit 6 which selects an output signal from the register 1 when a racing state is detected by the racing detection unit 5, and which selects an output signal from the data holding unit 2 and outputs the output signal thus selected when a racing state is not detected by the racing detection unit 5; a delaying unit 7 for generating a delay clock signal CK3 by further delaying the clock signal CK1 which has been delayed for a racing monitoring period and inverted by an inverter IV2; and a register 8 for writing an output signal from the selection unit 6 in response to a delay clock signal CK3.

The registers 1 and 8 include eight flip-flops F11 to F18 and F21 to F28, respectively. Each of the flip-flops F11 to F18 and F21 to F28 has a reset terminal, and an output is reset in response to a reset signal /RST.

Furthermore, the data holding unit 2 includes eight latches L11 to L18.

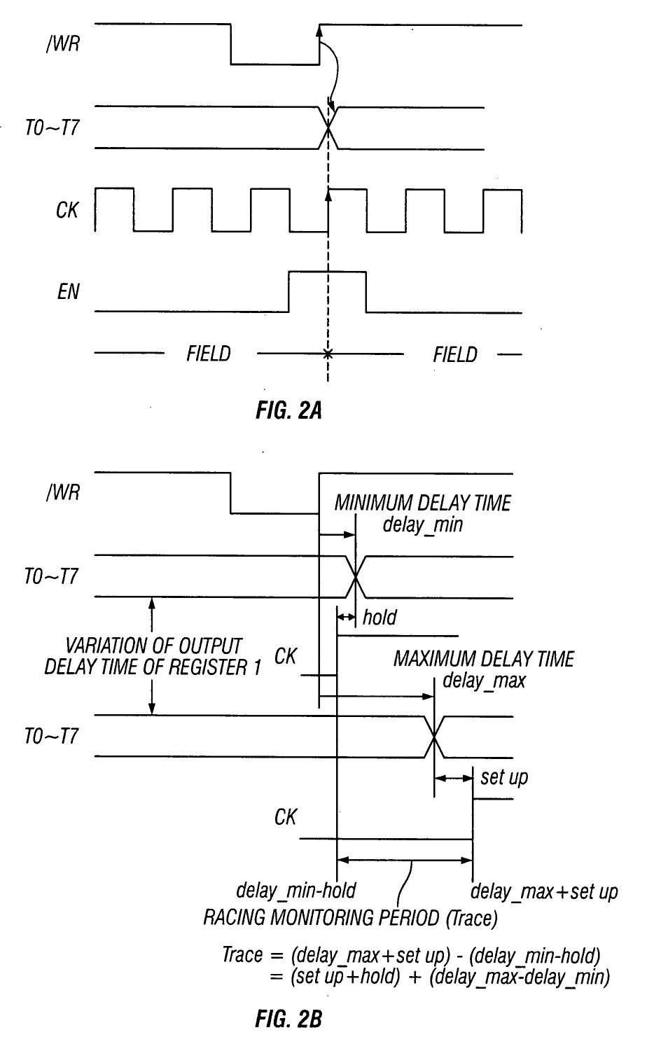

Since clock signals from the flip-flops F11 to F18 of the register 1 are asynchronous with clock signals from the flip-flops F21 to F28 of the register 8, a racing problem for the flip-flops F21 to F28 of the register 8 must be taken into consideration. This racing problem is described with reference to FIG. 2.

Here, first, consider the register 1 to which writing is performed in response to the write control signal /WR and the register 8 to which writing is performed in response to a clock signal CK in a case where a rise of the write control signal /WR is inputted in close proximity to a rise of the clock signal CK while the display cycle switching signal EN representing a changing point of a field is being inputted, as shown in FIG. 2A. At this time, the output of the output signals T0 to T7 from the register 1 is changed near the rise of the clock signal CK at the changing point of a field. In this case, it is uncertain which of the data before the change and the data after the change from the output signals T0 to T7 from the register 1 would be written to the register 8. Such a state is referred to as a racing state.

FIG. 2B is a diagram showing a phase relationship between the write control signal /WR and the clock signal CK when the racing occurs.

Here, it is assumed that a maximum delay time and a minimum delay time of the output signals T0 to T7 from the register 1 to be delay_max and delay_min, respectively, and that a set up time and a hold time required for the flip-flops F21 to F28 of the register 8 to be set up and hold, respectively.

The racing occurs when a phase difference of the clock signal CK to the write control /WR is in the range of (delay_min-hold) to (delay_max-set up). Incidentally, a period in which this racing occurs is set as a racing monitoring period (Trace) for monitoring whether the racing occurs in the output signals T0 to T7 of the register 1.

In other words, the Trace is given by Trace=(delay_max+set up)-(delay_min-hold)=(set up+hold)+(delay_max-delay_min).

In the present embodiment, the racing monitoring period setting unit 3, the data holding unit 4 and the racing detection unit 5 are provided to detect whether there is a changing point in the output signals T0 to T7 of the register 1 during this racing monitoring period.

The racing monitoring period setting unit 3 sets the above-described racing monitoring period, and outputs a clock signal CK2 which is the clock signal CK 1 delayed for a period corresponding to the period set as above.

The data holding unit 4 includes eight latches L21 to L28 which hold the output signals T0 to T7 from the register 1 in response to the clock signal CK2.

The racing detection unit 5 includes: Exclusive-NOR gate EX1 to EX8 as comparing means which compares, for every bit, output signals from the latches L11 to L18 included in the data holding unit 2 and output signals of the latches L21 to L28 included in the data holding unit 4; and a NAND gate ND1 to which outputs from the Exclusive-NOR gates EX1 to EX8 are inputted.

In order for the racing conditions of data inputs from the latches Lll to L18 and from the latches L21 to L28 to be adjusted for the register 8, a set up time and a hold time of the data inputs from the latches Lll to L18 and from the latches L21 to L28 are designed so as to be equal to a set up time and a hold time of the flip-flops F21 to F28 of the register 8.

The latches L11 to L18 included in the data holding unit 2 holds the outputs T0 to T7 of the register 1 in response to the clock signal CK1, and the latches L21 to L28 included in the data holding unit 4 holds the outputs T0 to T7 of the register 1 in response to the clock signal CK2 which is the clock signal CK1 delayed for a racing monitoring period. Accordingly, when any one of the output signals T0 to T7 from the register 1 changes during the racing monitoring period, any one of the latches L11 to L18 and the latches L21 to L28 holds a different value. Hence, any one of the Exclusive-NOR gates EX1 to EX8 outputs “0.” Consequently, the NAND gate ND1 outputs

Meanwhile, when the output signals T0 to T7 of the register 1 do not change during the racing monitoring period, the latches L11 to L18 and the latches L21 to L28 holds the same values. Hence, all the Exclusive-NOR gates EX1 to EX8 output “1”, and the NAND gate ND1 outputs “0”.

More specifically, when the output signals T0 to T7 of the register 1 change during the racing monitoring period, the racing detection unit 5 outputs “1”, indicating that the output signals T0 to T7 of the register 1 are in the racing state to the clock signal CK. On the other hand, when the output signals T0 to T7 of the register 1 don't change, the racing detection unit 5 outputs “0”.

The selection unit 6 selects input address in response to a signal outputted from the racing detection unit 5. The data holding unit 2 and the register 1 are the input addresses to be selected. The selection unit 6 outputs a selected input to the register 8.

When an output signal from the racing detection unit 5 is “0”, the selection unit 6 selects an output from the data holding unit 2 since there is no possibility that the racing occurs in data held in the data holding unit 2 in response to the clock signal CK1.

On the other hand, when an output signal from the racing detection unit 5 is “1”, the selection unit 6 selects an output from the register 1 since there is a possibility that the racing occurs in the data held in the data holding unit 2 in response to the clock signal CK1. In other words, when an output signal from the racing detection unit 5 is “1”, not the data held by the clock signal CK1 that may cause the racing, but an output from the register 1 is outputted to the register 8 as it is.

The register 8 writes an output signal from the selection unit 6 in response to the delay clock signal CK3 which is the clock signal CK1 delayed until after the racing monitoring period. Accordingly, even when an output from the register 1 is inputted from the selection unit 6, an output from the register 1 can be written with no racing occurred.

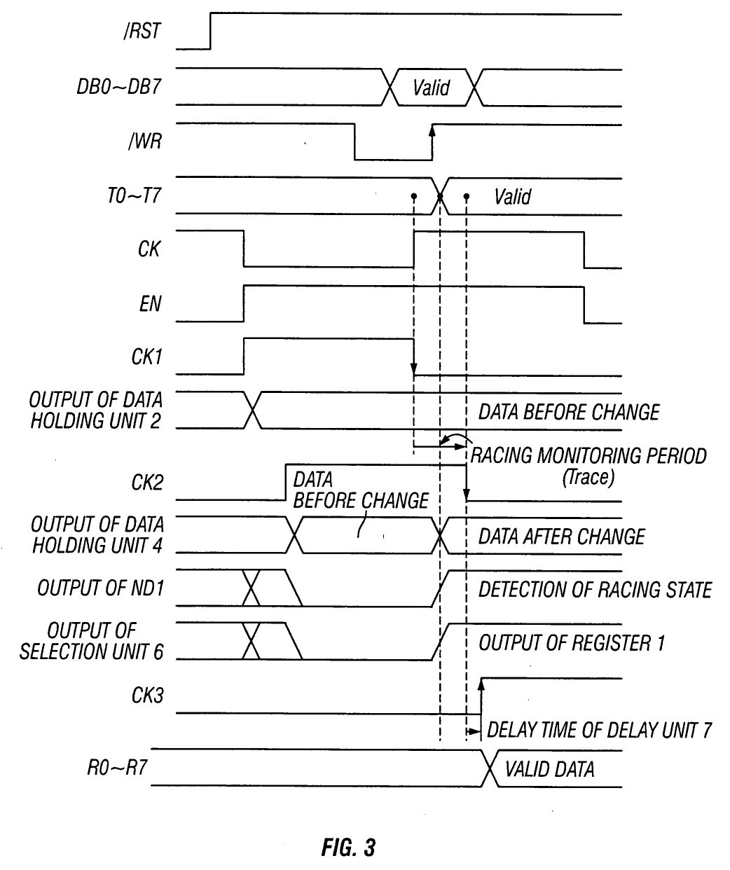

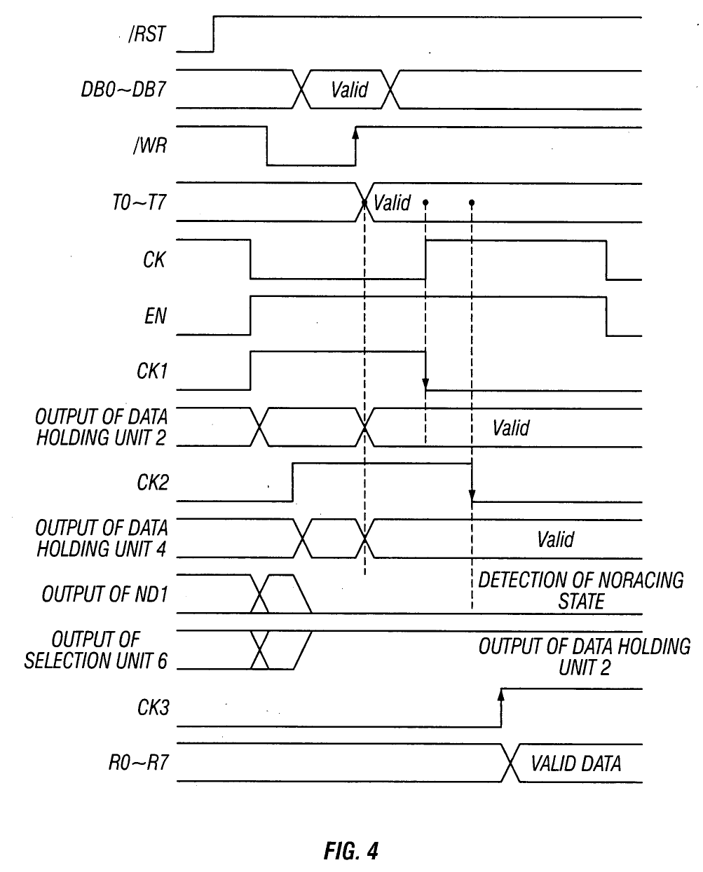

FIGS. 3 and 4 are waveform charts each showing an example of operation according to the present embodiment.

FIG. 3 shows an operation at a time when a rise of the write control signal /WR is inputted near a rise of the clock signal CK while the display cycle switching signal EN is inputted. Here, it is assumed that the clock signal CK rises before the write control signal /WR rises.

The data holding unit 2 holds the output signals T0 to T7 from the register 1 in response to the falling of the clock signal CK1 that changes before the write control signal /WR rises. Accordingly, at this time, the data holding unit 2 holds data (data before the change) before the data is rewritten into new data.

In contrast, the data holding unit 4, which holds the output signals T0 to T7 from the register 1 at the falling of the clock signal CK2 which is delayed for a racing monitoring period (Trace)than the clock signal CK1, holds data (data after changing) after the rewriting of the data into new data is completed.

As described above, since data held by the data holding unit 2 and data held by the data holding unit 4 are different from each other, the signal “1” indicating the detection of the racing is outputted from the racing detection unit 5 and the NAND gate ND1.

Then, the selection unit 6 selects an output of the register 1, and outputs the output to the register 8.

The register 8 writes the output of the register 1 in response to the delay clock signal CK3 delayed for a delaying time of the delaying unit 7 than the clock signal CK2. At this time, since there is a sufficient amount of time between a changing point of a signal of the output signals T0 to T7 from the register 1 and a rise of the delay clock signal CK3, the racing does not occur in the register 8. For this reason, to output signals R0 to R7 from the register 8, new data (Valid data) written in response to a write control signal /WR is outputted without fail.

On the other hand, FIG. 4 shows an operation when a rise of the write control signal /WR is inputted at a time being away from a rise of the clock signal CK while the display cycle switching signal EN is inputted. Here, it is assumed that the clock signal CK rises after the write control signal /WR rises.

At this time, the data holding unit 2 which holds the output signals T0 to T7 from the register 1 at the falling of the clock signal CK1, and the data unit 4 which holds the output signals T0 to T7 from the register 1 at the falling of the clock signal CK2 include newly rewritten data (Valid data).

Hence, the signal “0” indicating the non-detection of the racing is outputted from the NAND gate ND1 of the racing detection unit 5.

The selection unit 6 selects an output from the data holding unit 2, and outputs the output to the register 8.

The register 8 writes the output from the data holding unit 2 in response to the delay clock signal CK3. Since there is a sufficient amount of time between a changing point of the output signal from the data holding unit 2 and the rise of the delay clock signal CK3, at this time also, the racing does not occur in the register 8. For this reason, to the output signals R0 to R7 from the register 8, new data (Valid data) written in response to the write control signal /WR is outputted without fail.

Incidentally, in the present embodiment, although an output signal from the data holding unit 2 is used as a signal to be inputted to the selection unit 6, an output signal from the data holding unit 4 may be used in stead of the output signal from the data holding unit 2.

According to the present embodiment as mentioned above, it is detected whether or not the racing state occurs at a changing time point of an output signal from a first stage register, to which the setting values from the CPU are written in response to the write control signal /WR, in response to the clock signal while the display cycle switching signal EN is inputted. When the racing state is detected, the output signal from the first stage register is written to a second stage register in response to the clock signal which is the clock signal CK delayed until after the period when the racing occurs while the display cycle switching signal EN is inputted. This makes it possible that, even when a timing of generating the write control signal and a timing of switching the display cycle are close to each other, setting values are written to the second stage register without racing, and that the setting values are stably updated at the timing of switching the display cycles.

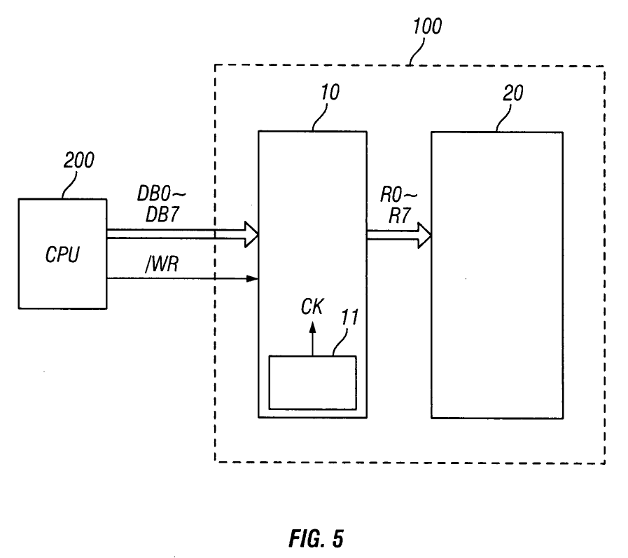

FIG. 5 is a block diagram showing an example of a configuration of an essential part of a liquid crystal display device 100 on which a liquid crystal display driver 10 of the first embodiment is mounted.

The liquid crystal display device 100 includes the liquid crystal display driver 10, and a liquid crystal panel 20. It is assumed that the liquid crystal display driver 10 includes an internal oscillating circuit 11 for outputting a clock signal CK.

To the liquid crystal display driver 10, setting value data DB0 to DB7 and a write control signal /WR on the display of the liquid crystal panel 20 are inputted from a CPU 200. The write control signal /WR is a signal asynchronous with the clock signal CK outputted from the internal oscillating circuit 11 of the liquid crystal display driver 10.

The liquid crystal display driver 10 outputs the setting value data DB0 to DB7 written in response to the write control signal /WR asynchronous with the clock signal CK to the liquid crystal panel 20 as setting value data R0 to R7 which change at the timing of switching of display cycles, with no error occurred in the writing of data due to the racing caused by asynchronous writing.

The liquid crystal panel 20 changes the setting for display at the timing of switching of the display cycles in response to the setting value data R0 to R7 inputted from the liquid crystal display driver 10.

According to the present embodiment, even when setting values for the display of the liquid crystal panel are written by the CPU asynchronous with the switching of the display cycles, the setting values for the display of the liquid crystal panel can be changed at the timing of switching of the display cycles. Furthermore, since the setting values do not become the unintended values, it is possible to prevent the display of the liquid crystal panel from being disturbed, when changing setting values.

What is claimed is:

1. A liquid crystal display driver comprising:
a first register for writing a setting value for display in response to a write control signal asynchronous with a clock signal outputted at a timing of switching display cycles;
first data holding unit which holds an output from the first register in response to the clock signal;
racing monitoring period setting unit which sets a period for monitoring an occurrence of racing in the output signal from the first register due to the timing of the clock signal;
second data holding unit which holds an output from the first register in response to a clock signal which is the clock signal delayed for a period set by the racing monitoring period setting unit;
racing detection unit which detects whether a racing state occurs in the output signal from the first register due to a timing of the clock signal;
selection unit which outputs an output signal from the first register when the racing state is detected by the racing detection unit, and which outputs an output signal from the first data holding unit when the racing state is not detected by the racing detection unit;
delay unit which generates a delay clock signal which is the clock signal delayed until after the period set by the racing monitoring period setting unit; and
a second register for writing an output signal from the selection unit in response to the delay clock signal.

2. The liquid crystal display driver according to claim 1, wherein the racing detection unit includes comparator which compares the output signal from the first data holding unit and the output signal from the second data holding unit.

3. The liquid crystal display driver according to claim 1, wherein a set up time and a hold time required for the first data holding unit and a data input signal from the second data holding unit are respectively equal to a set up time and a hold time required for a data input signal from the second register.

4. The liquid crystal display driver according to claim 1, wherein the racing monitoring period setting unit sets, as the racing monitoring period, a value obtained by adding the difference between a maximum value and a minimum value of an output delay time of the first register to the sum of the set up time and the hold time required for the data input signal from the second register.

5. A liquid crystal display driver comprising:
a first register for writing a setting value for display in response to a write control signal asynchronous with a clock signal outputted at a timing of switching display cycles;
first data holding unit which holds an output from the first register in response to the clock signal;
racing monitoring period setting unit which sets a period for monitoring an occurrence of racing in the output signal from the first register due to the timing of the clock signal;
second data holding unit which holds an output from the first register in response to a clock signal which is the clock signal delayed for a period set by the racing monitoring period setting unit;
racing detection unit which detects whether a racing state occurs in the output signal from the first register due to a timing of the clock signal;
selection unit which outputs an output signal from the first register when the racing state is detected by the racing detection unit, and which outputs an output signal from the second data holding unit when the racing state is not detected by the racing detection unit;
delay unit which generates a delay clock signal which is the clock signal delayed until after the period set by the racing monitoring period setting unit; and
a second register for writing an output signal from the selection unit in response to the delay clock signal.

6. The liquid crystal display driver according to claim 5, wherein the racing detection unit includes comparator which compares the output signal from the first data holding unit and the output signal from the second data holding unit.

7. The liquid crystal display driver according to claim 5, wherein a set up time and a hold time required for the first data holding unit and a data input signal from the second data holding unit are respectively equal to a set up time and a hold time required for a data input signal from the second register.

8. The liquid crystal display driver according to claim 5, wherein the racing monitoring period setting unit sets, as the racing monitoring period, a value obtained by adding the difference between a maximum value and a minimum value of an output delay time of the first register to the sum of the set up time and the hold time required for the data input signal from the second register.

9. A liquid crystal display device comprising:
a liquid crystal display driver having;
a first register for writing a setting value for display in response to a write control signal asynchronous with a clock signal outputted at a timing of switching display cycles;
first data holding unit which holds an output from the first register in response to the clock signal;
racing monitoring period setting unit which sets a period for monitoring an occurrence of racing in the output signal from the first register due to the timing of the clock signal;
second data holding unit which holds an output from the first register in response to a clock signal which is the clock signal delayed for a period set by the racing monitoring period setting unit;
racing detection unit which detects whether a racing state occurs in the output signal from the first register due to a timing of the clock signal;
selection unit which outputs an output signal from the first register when the racing state is detected by the racing detection unit, and which outputs an output signal from the first data holding unit when the racing state is not detected by the racing detection unit;
delay unit which generates a delay clock signal which is the clock signal delayed until after the period set by the racing monitoring period setting unit; and
a second register for writing an output signal from the selection unit in response to the delay clock signal: and
a liquid crystal panel
wherein the liquid crystal display driver changes setting for display of the liquid crystal panel at a timing of switching display cycles, in response to a setting value inputted from a CPU.

10. The liquid crystal display device according to claim 9, wherein the racing detection unit includes comparator which compares the output signal from the first data holding unit and the output signal from the second data holding unit.

11. The liquid crystal display device according to claim 9, wherein a set up time and a hold time required for the first data holding unit and a data input signal from the second data holding unit are respectively equal to a set up time and a hold time required for a data input signal from the second register.

12. The liquid crystal display device according to claim 9, wherein the racing monitoring period setting unit sets, as the racing monitoring period, a value obtained by adding the difference between a maximum value and a minimum value of an output delay time of the first register to the sum of the set up time and the hold time required for the data input signal from the second register.

13. A liquid crystal display device comprising:
a liquid crystal display driver having;
a first register for writing a setting value for display in response to a write control signal asynchronous with a clock signal outputted at a timing of switching display cycles;
first data holding unit which holds an output from the first register in response to the clock signal;
racing monitoring period setting unit which sets a period for monitoring an occurrence of racing in the output signal from the first register due to the timing of the clock signal;
second data holding unit which holds an output from the first register in response to a clock signal which is the clock signal delayed for a period set by the racing monitoring period setting unit;
racing detection unit which detects whether a racing state occurs in the output signal from the first register due to a timing of the clock signal;
selection unit which outputs an output signal from the first register when the racing state is detected by the racing detection unit, and which outputs an output signal from the second data holding unit when the racing state is not detected by the racing detection unit;
delay unit which generates a delay clock signal which is the clock signal delayed until after the period set by the racing monitoring period setting unit; and
a second register for writing an output signal from the selection unit in response to the delay clock signal: and
a liquid crystal panel
wherein the liquid crystal display driver changes setting for display of the liquid crystal panel at a timing of switching display cycles, in response to a setting value inputted from a CPU.

14. The liquid crystal display device according to claim 13, wherein the racing detection unit includes comparator which compares the output signal from the first data holding unit and the output signal from the second data holding unit.

15. The liquid crystal display device according to claim 13, wherein a set up time and a hold time required for the first data holding unit and a data input signal from the second data holding unit are respectively equal to a set up time and a hold time required for a data input signal from the second register.

16. The liquid crystal display device according to claim 13, wherein the racing monitoring period setting unit sets, as the racing monitoring period, a value obtained by adding the difference between a maximum value and a minimum value of an output delay time of the first register to the sum of the set up time and the hold time required for the data input signal from the second register.
